(19) United States
(12) Patent Application Publication
(10) Pub. No.: US 2009/0041653 A1
(43) Pub. Date: Feb. 12, 2009

(54) Method for the preparation of porous graphite carbon with high crystallinity using sucrose as a carbon precursor

(75) Inventors: In Chul Hwang, Gyeonggi-do (KR); Jong Heop Yi, Seoul (KR); Ji Bong Joo, Gyeongsangnam-do (KR); Nak Hyun Kwon, Seoul (KR); Pil Kim, Gyeongsangbuk-do (KR)

Correspondence Address: Edwards Angell Palmer & Dodge LLP, P.O. Box 55874, Boston, MA, 02205, US

(73) Assignee: Hyundai Motor Company, Seoul (KR)

(21) Appl. No.: 11/999,969

(22) Filed: Dec. 7, 2007

(30) Foreign Application Priority Data
Aug. 8, 2007 (KR) 10-2007-0079768

(51) Int. Cl. C01B 31/04

(52) U.S. Cl. 423/448

(57) ABSTRACT

The present invention relates to a process for preparing a porous graphite carbon with high crystallinity, which comprises the steps of: (a) hydrothermally treating sucrose (i.e. carbon precursor), transitional metal precursor and uniform-sized silica particles at the same time to prepare a polymer; and (b) carbonizing the polymer, which can provide a porous graphite carbon with remarkably improved crystallinity suitable for a catalyst support for a fuel cell.

### CROSS-REFERENCE TO RELATED APPLICATION

This application claims under 35 U.S.C. §119(a) on Korean Patent Application No. 10-2007-0079768, filed on Aug. 8, 2007, the entire contents of which are incorporated herein by reference.

### TECHNICAL FIELD

The present invention relates to a process for preparing a porous graphite carbon with high crystallinity by using sucrose, which is an eco-friendly and harmless. More particularly, the present invention relates to a process for preparing a porous graphite carbon with high crystallinity, which comprises hydrothermally treating sucrose (i.e. carbon precursor), transitional metal precursor and uniform-sized silica particles at the same time to prepare a polymer, and carbonizing the polymer.

### BACKGROUND ART

Porous carbon materials have been used as an absorbent and a catalyst support due to its high specific surface area and pore volume and its stability to acid and base. In particular, with the development of low-temperature fuel cell, porous carbon materials have drawn attention as a catalyst support of a fuel cell. To be used a catalyst support for a fuel cell, they are required to have high specific surface area for containing larger amount of metal. Further, they must have large pore size for facilitating the three phase boundary formation of catalyst-reactant-electrolyte. Furthermore, they must have high conductivity and resistance to electro-chemical oxidation. Crystalline carbon (graphite), has been used as a catalyst support.

In one conventional method, crystalline carbon is prepared by performing chemical deposition or arc discharge to grow carbon on nano-particles. However, this process requires high-priced device and the yield is not sufficiently high.

In another method, crystalline carbon is prepared by polymerizing metal catalyst with carbon precursor, carbonizing the polymer, and removing the metal catalyst. However, the carbon precursors that can be used in this process are harmful.

Korean Patent Application Laid-Open Publication Nos. 2002-97295 and 2002-84372 disclose a process where sucrose, which is eco-friendly, is used as carbon precursor. However, using sucrose as carbon precursor can result in amorphous carbon. [e.g., Korean Patent Publication Nos. 2002-97295 and 2002-84372].

### SUMMARY OF THE INVENTION

The present invention has been made in an effort to solve the above-described problems associated with prior art. In one aspect, the present invention provides a process for preparing crystalline porous graphite carbon, which comprises the steps of: (a) hydrothermal treating sucrose (a carbon precursor), transitional metal precursor and uniform-sized silica particles at the same time to prepare a polymer; and (b) carbonizing the polymer. In this process, the metal precursor promotes the catalytic activity to increase the degree of polymerization during the polymerization and the carbonization, forms a polymeric structure that facilitates crystalline carbon formation, and increases the carbon crystallinity during carbonization.

One preferred embodiment of the present invention comprises the steps of: (a) dispersing sucrose, transitional metal precursor and silica particles in distilled water and conducting hydrothermal treatment to prepare a polymer; (b) drying the polymer and conducting thermal treatment at 700-1500° C. under vacuum or with an inert gas to prepare a composite; and (c) treating the composite with fluoric acid or sodium hydroxide solution, followed by washing and filtration to prepare a porous graphite carbon.

Other preferred embodiments of the invention are discussed infra.

According to the preferred embodiments of the present invention, a porous graphite carbon with high crystallinity can be conveniently prepared by using as a carbon precursor sucrose prepared by a harmless and eco-friendly process. Also, porosity property can be controlled by varying the size and shape of silica particles. Further, a crystalline porous graphite carbon prepared according to the present invention provides improved catalytic activity when used as catalyst support for a fuel cell.

### BRIEF DESCRIPTION OF THE DRAWINGS

FIG. 1 shows SEM and high-resolution TEM images of a porous graphite carbon prepared in Example 1 (FIGS. 1 (a) and (b)) and a carbon prepared in Comparative Example 1 (FIGS. 1 (c) and (d)).

FIG. 2 shows X-ray diffraction patterns of a porous graphite carbon prepared in Example 1 and a carbon prepared in Comparative Example 2.

FIG. 3 shows Raman analysis results of a porous graphite carbon prepared in Example 1, a carbon prepared in Comparative Example 3 and a multi-walled carbon nanotube.

FIG. 4 shows X-ray diffraction patterns of a porous graphite carbon prepared in Example 2 and carbons prepared in Comparative Examples 4-5.

### DETAILED DESCRIPTION

Reference will now be made in detail to the preferred embodiments of the present invention. The embodiments are described below so as to explain the present invention by referring to the figures.

As discussed above, the present invention provides a process for preparing a porous graphite carbon with high crystallinity by using sucrose, which is an eco-friendly and harmless.

More particularly, according to preferred embodiments of the present invention, a polymer is prepared by hydrothermally treating a mixture of sucrose with a certain transitional metal precursor and silica particles and the polymer is carbonized to prepare a porous graphite carbon with high crystallinity.

The catalytic activity of the transitional metal precursor increases the degree of polymerization, forms a polymeric structure that facilitates crystalline carbon formation and increases carbon crystallinity during carbonization.

Preferably, the transitional metal precursor is a metal salt that can form a polymeric structure facilitating crystalline carbon formation and increasing crystallinity. Examples of the metals include iron, cobalt, nickel, copper and zinc. Examples of the salt form of the metals include nitrate, sulfate, chloride, ammonium and hydrated salt. One or more of the metal salts can be used. Among these, nitrate is preferred, and iron nitrate (Fe(NO₃)₃.H₂O) is more preferred.

Korean Patent Publication Nos. 2002-9729 and 2002-84372 disclose nitric acid derivative or chloric acid as a polymeric catalyst. However, with this catalyst, carbon can be provided by polymerization and carbonization, but crystalline carbon cannot be provided.

Hereunder is provided a detailed description of the processes according to the present invention.

As the first step, a polymer is prepared by dispersing sucrose (carbon precursor), transitional metal precursor and silica particles in distilled water and conducting hydrothermal treatment.

Any commercially available sucrose may be used in the present invention. A preferred concentration of sucrose is 3-20 wt %. When the concentration is lower than 3 wt %, the yield of graphite carbon may not be sufficiently high. When the concentration is higher than 20 wt %, it may be difficult to control the physiochemical properties of carbon.

Transitional metal precursor is preferred to be used in a molar ratio of 0.3-3 relative to one mole of sucrose. When the ratio is lower than 0.3, the crystallinity of carbon may not be sufficiently high. When the ratio is higher than 3, it may be difficult to control the porosity of carbon.

Although silica particles of any size and shape that are used in the field, to which the present invention pertains to, can be used, spherical shape of 20 nm-1 μm is preferred depending on the desired porosity size and property of carbon. When the particle size is lower than 20 nm, carbon support with uniform pores may not be produced. When the size is higher than 1 μm, a silica mold may not serve its purpose due to the separation of the mold and carbon. Silica particles are preferred to be used in a molar ratio of 0.25-2 relative to one mole of sucrose. When the ratio is lower than 0.25, the surface area and pore volume of carbon may decrease. When the ratio is higher than 2, it may be difficult to control the property of carbon.

Hydrothermal treatment may be conducted in any conventional manner without limitation in an autoclave that may endure a pressure of higher than 10 bars. Preferably, hydrothermal treatment is conducted at 150-300° C. for 7-48 hours. When the temperature is lower than 150° C., the yield of carbon is not sufficiently high. When the temperature is higher than 300° C., the operation may be difficult to control during the hydrothermal treatment. When the time is less than 7 hours, the yield of carbon may not be sufficiently high. The effect may level off at a time over 48 hours.

As the second step, the polymer thus-obtained is dried and thermally treated (carbonized) under vacuum or with an inert gas.

The drying is conducted at 80-200° C. for 12-48 hours. When the temperature is lower than 80° C., the polymer may not be dried sufficiently. The drying effect may level off at a temperature over 200° C.

Thermal treatment may be conducted in any conventional manner. Preferably, however, the thermal treatment (carbonization) is conducted at 700-1500° C. to provide a carbon-silica composite containing transitional metal precursor. When the temperature is lower than 700° C., the crystallinity of carbon may not be sufficient. When the temperature is higher than 1500° C., the surface area of carbon and the porosity size may decrease because the carbon may contract during the thermal treatment.

As the third step, the composite is treated with fluoric acid or sodium hydroxide solution, followed by washing, filtration and drying, thereby providing crystalline porous graphite carbon.

This treatment with fluoric acid or sodium hydroxide solution is conducted by immersing the composite in the solution for 3-24 hours for removing silica and metal in the composite. The concentration of the solution is preferably within 1-5 M. When the concentration is lower than 1 M, the removal of silica and metal may not be sufficient. The effect may level off at the concentration over 5 M.

The drying is conducted at a temperature high enough to evaporate distilled water, preferably at 80-100° C.

Thus-prepared graphite carbon has a specific surface area of 260-500 m²/g and high crystallinity, thus being suitable for a catalyst support, especially in the fuel cell field.

### EXAMPLES

The present invention is described more specifically by the following Examples. Examples herein are meant only to illustrate the present invention, but in no way to limit the scope of the claimed invention.

### Example 1

Silica particles (5 g) with a size of 100 nm were uniformly dispersed in a solution prepared by mixing iron nitrate (9.0 g) and sucrose (10.0 g) in distilled water (150 mL). Hydrothermal treatment was conducted by stirring the dispersion in an autoclave at 190° C. for 9 hours. The products were filtered, dried at 120° C. for 12 hours and thermally treated at 1000° C. under a nitrogen condition for 3 hours (carbonization). The carbonized material contained silica particles and iron component, and was washed by the treatment of a solution (3 M) containing fluoric acid or sodium hydroxide for 12 hours, followed by filtration and drying at 80° C., thereby providing a crystalline and porous graphite carbon.

### Example 2

A crystalline and porous graphite carbon was prepared in the manner same as in Example 1 except that cobalt or nickel was used as a metal precursor.

### Comparative Example 1

A carbon was prepared in the manner same as in Example 1 except that the silica particles were not used.

### Comparative Example 2

A carbon was prepared in the manner same as in Example 1 except that the iron nitrate was not used.

### Comparative Example 3

A carbon was prepared in the manner same as in Example 1 except that the hydrothermal treatment was not conducted.

### Comparative Example 4

A carbon was prepared in the manner same as in Example 1 except that nitric acid (1 M) was used as a nitric acid derivative instead of iron nitrate.

### Comparative Example 5

A carbon was prepared in the manner same as in Example 1 except that sodium nitrate was used as a metal derivative instead of iron nitrate.

### Experimental Example 1

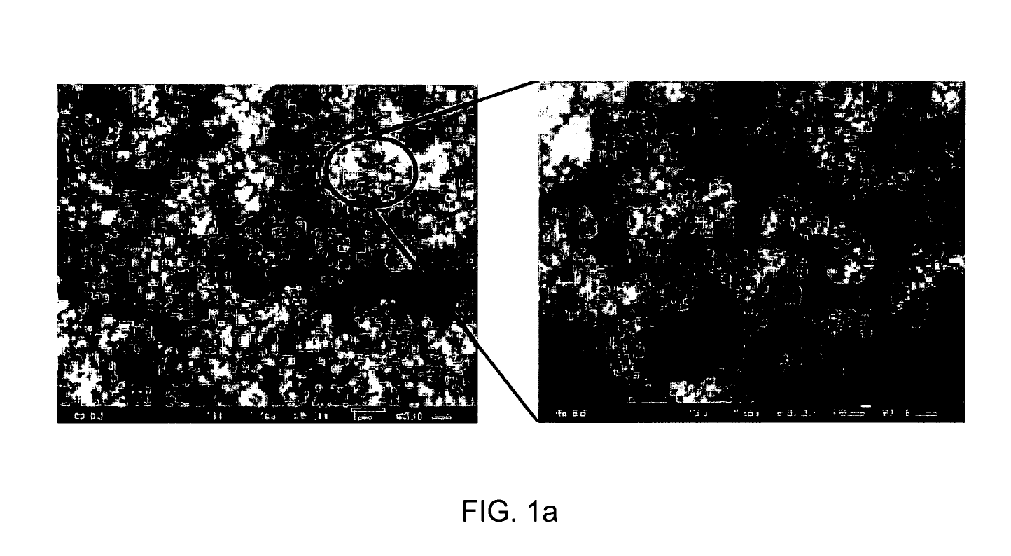

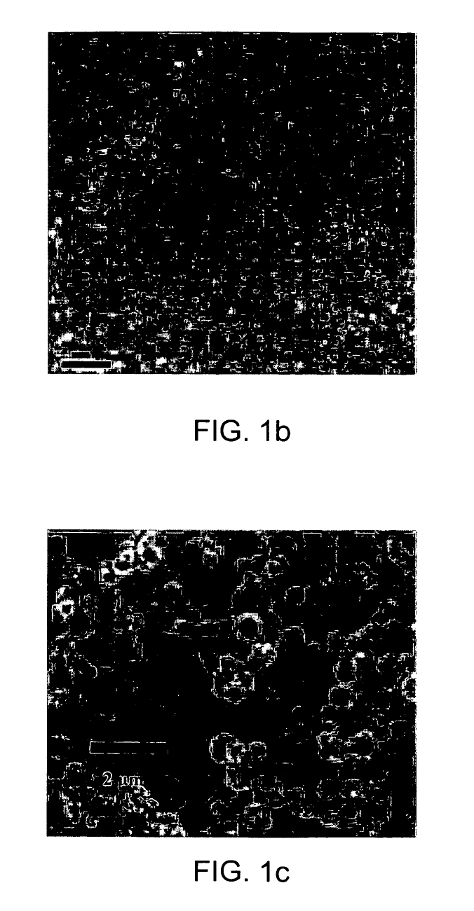

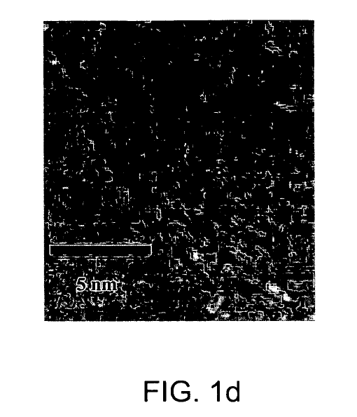

FIG. 1 shows SEM and high-resolution TEM images of a porous graphite carbon prepared in Example 1 and a carbon prepared in Comparative Example 1.

FIGS. 1(a) and 1(b) ascertain high porosity and crystallinity of the graphite carbon, respectively. In contrast, FIGS. 1(c) and 1(d) show that carbons prepared without using silica particles have spherical shape without crystallinity.

### Experimental Example 2

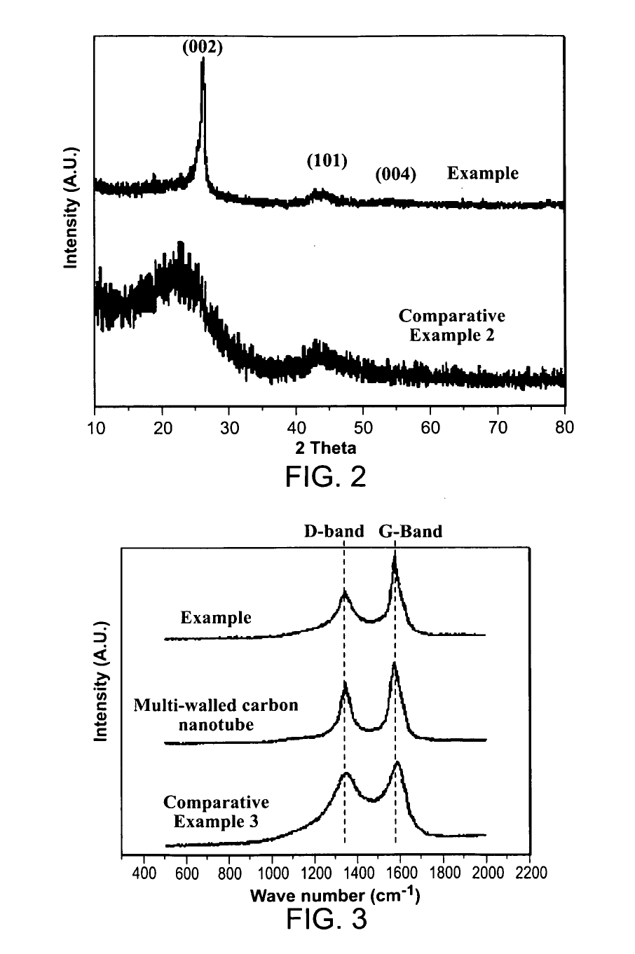

FIG. 2 shows X-ray diffraction patterns of a porous graphite carbon prepared in Example 1 and a carbon prepared in Comparative Example 2. Comparative Example 3 shows the same X-ray diffraction result with Comparative Example 2.

Carbon prepared in Comparative Example 2 was amorphous with no crystallinity peak detected, while graphite carbon prepared in Example was ascertained to be highly crystalline, showing well-developed graphite characteristic peaks.

These results mean hydrothermal treatment must be conducted in the presence of metal salt for preparing crystalline carbon by using sucrose as carbon precursor.

### Experimental Example 3

FIG. 3 shows Raman analysis results of a porous graphite carbon prepared in Example 1, a carbon prepared in Comparative Example 3 and a multi-walled carbon nanotube. Comparative Example 2 shows the same Raman analysis result with Comparative Example 3. Raman analysis of multi-walled carbon nanotube is also shown for comparison.

The carbons obtained showed two major peaks: a peak at 1360 cm⁻¹ (D-band) is due to specific crystallinity of carbon, and a peak at 1580 cm⁻¹ (G-band) is closely related to crystallinity of carbon. In general, the crystallinity of carbon is represented by an areal ratio of 1360 cm⁻¹ peak to 1580 cm⁻¹ peak. The areal ratio of the porous graphite carbon is lower than that of the carbon prepared in Comparative Example, which shows that the porous graphite carbon has a relatively high crystallinity and that the crystallinity is comparable to that of multi-walled carbon nanotube.

### Experimental Example 4

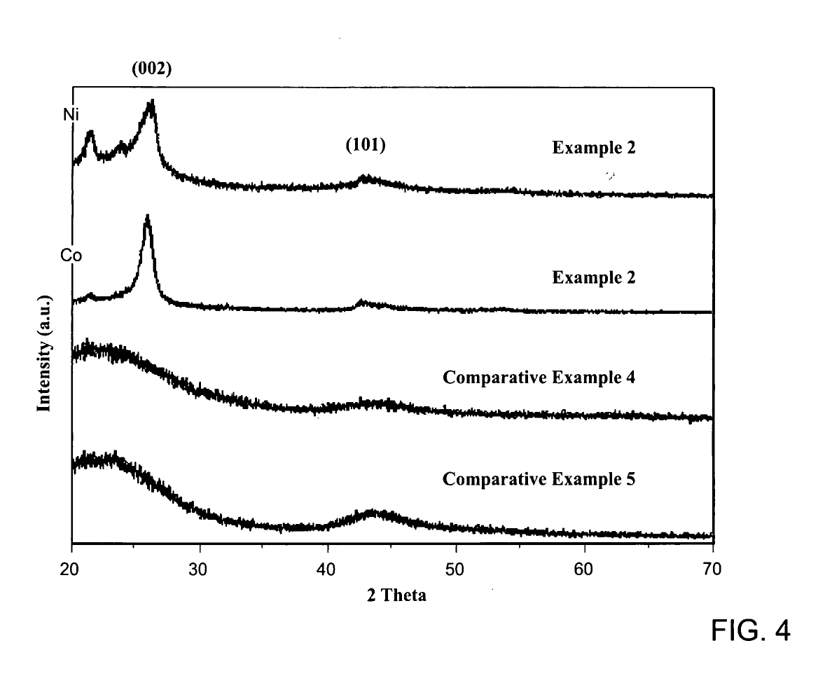

FIG. 4 shows X-ray diffraction patterns of a porous graphite carbon prepared in Example 2, where cobalt or nickel is used as a metal precursor, and carbons prepared in Comparative Examples 4-5.

FIG. 4 ascertains that carbons prepared in Comparative Example 4-5 are amorphous while graphite carbon prepared in Example 2 show well-grown crystallinity. Low peaks related to nickel or cobalt species were also detected at low angle.

These results indicate that the use of metal (e.g. nickel or cobalt) salt is preferred for preparing crystalline carbon by using sucrose as carbon precursor.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A process for preparing a porous graphite carbon with high crystallinity, which comprises the steps of:
(a) dispersing sucrose, transitional metal precursor and silica particles in a distilled water and conducting hydrothermal treatment to prepare a polymer;
(b) drying the polymer and conducting a thermal treatment at 700-1500° C. under vacuum or with an inert gas to prepare a composite; and
(c) treating the composite with a fluoric acid or a sodium hydroxide solution.

2. The process of claim 1, wherein the concentration of the sucrose is 3-20 wt %.

3. The process of claim 1, wherein the transitional metal precursor is a metal salt, the metal is selected from the group consisting of iron, nickel and cobalt and the salt is selected from the group consisting of nitrate, sulfate, chloride, ammonium and hydrated salt.

4. The process of claim 1, wherein the transitional metal precursor is used in a molar ratio of 0.3-3 relative to one mole of sucrose.

5. The process of claim 1, wherein the silica particles have a size of 20 nm-1 μm.

6. The process of claim 1, wherein the silica particles are used in a molar ratio of 0.25-2 relative to one mole of sucrose.

7. The process of claim 1, wherein the hydrothermal treatment is conducted at 150-300° C.

8. The process of claim 1, wherein the graphite carbon has a specific surface area of 260-500 cm²/g.

9. A catalyst for a fuel cell comprising a graphite carbon prepared according to claim 1 as a support.
